(19) United States
(12) Patent Application Publication
(10) Pub. No.: US 2011/0272956 A1
(43) Pub. Date: Nov. 10, 2011

(54) ROUND SLING AND METHOD FOR MANUFACTURING SAME

(75) Inventor: Seoung Nam Bae, Gyeonggi-do (KR)

(73) Assignee: Geun Im YOO, Gimhae-si, Gyeongsangnam-do (KR)

(21) Appl. No.: 13/145,561

(22) PCT Filed: Jan. 20, 2010
(86) PCT No.: PCT/KR2010/000357

§ 371 Date: Jul. 20, 2011

(30) Foreign Application Priority Data
Jan. 20, 2009 (KR) 10-2009-0004556

(51) Int. Cl. B66C 1/18; B66C 1/12; D07B 5/00

(52) U.S. Cl. 294/74; 57/362

(57) ABSTRACT

The present invention relates to a round sling, and more particularly, to a round sling and to a method for manufacturing same in which threads are twisted according to a predetermined fracture, coated with a conductor, and extrusion-molded together with a core tube. The thus-manufacturing round sling can be determined to be undamaged and used when the round sling conducts electric currents, and prevented from being used when the round sling does not conducts electric current and the round sling is determined to be damaged at a level higher than a preset damage level. Thus, the round sling of the present invention prevents negligent accidents.

### TECHNICAL FIELD

The present invention relates to a round sling, and in particular to a round sling and a method for manufacturing the same in which threads are twisted at a predetermined fracture ratio, coated with a conductor and extrusion-molded with a core tube, and the thus-manufactured round sling can be determined to be undamaged and used when the round sling conducts electric current, and prevented from being used when the round sling does not conduct electric current and the round sling is determined to be damaged at a level higher than a preset damage level, thus preventing negligent accidents, and the twisted threads are wound and arranged for the use at an outer cover tube in an extrusion-molded state along with a core tube for a preset weight, and a joint is finishing work is performed, so an outer cover tube and a core tube are not damaged at the time of unloading heavy things, thus extending service life.

### BACKGROUND ART

Round sling, generally, represents a flexible round sling in which a core formed of threads to support the weighs of unloading things is completely covered within an outer cover and is formed of a two-end eye type, an endless type, and a device-mounted type.

The structure of a conventional round sling is characterized in that threads are twisted to form a core, and the core is covered by an outer cover and sewed, and the both ends of the longitudinal direction of the outer cover are connected by sewing, and a protection member and an indication label are attached to the outer cover.

The method for manufacturing a conventional round sling will be described. Threads are twisted and plaited, and a winding work is performed. A to sewing work for attaching a joint portion and label after arranging the outer cover is performed, and then a packing work is performed.

During the work for twisting and plaiting the threads, a twisting work is performed in order to manufacture a round sling ‘core’ after a high tensional force thread material (for example, polyester, etc) is imported. In this case, a work for plaiting high tensional threads is performed based on a design plan containing an appropriate revolution and strength meeting a standard. A weaving work is performed to perform an outer cover and protection member work. Here, a high tensional thread is suspended over beams, and a warp work is performed, and a weaving work is performed depending on a standard (width).

In the conventional round sling, as the revolution of the core increases, the tangling of the wound cores occurs, which results in damaging in another portion when the cores are damaged. When the cores are wound, a pulling phenomenon occurs. The repeating or continuing use at a corner portion might result in the abrasion and tearing of the outer cover, so the outer cover might be damaged, and the strength of the core is lowered.

In other words, the conventional round sling has a problem that when cores are broken and fractured, the portion fractured by the tensional force is contracted and is tangled with another core. Due to repeating use, part of the skein might bring damage to friction or pecked portion. Since a core check at the portion where receiving loads in the course of check for the use of round sling cannot be performed, it is not clear how to check the damaged degree of the product or how to determine the disposal of the product. In case of the woven outer cover, a specific portion becomes sharp, and when the skein is loosened by a friction, abrasion, etc., a continued damage at the outer cover occurs. The outer cover is sewed using a sewing thread having the same material and a strength higher than equivalent. The sewed portion penetrates the core and might damage the strength of the core. Skein might be loosened from the sewed portion due to friction or at a sharp portion.

### DISCLOSURE OF INVENTION

Accordingly, the present invention is provided to overcome the problems encountered in the conventional art. In the present invention, and it is an object of the present invention to provide a round sling and a method for manufacturing the same in which a conductor-coated core in which threads formed of multiple strands are twisted is covered by an elastic core tube and is wound on an outer skin tube and is arranged, and the threads protruded from both ends of the core tube are extended into the interior of the outer skin tube and are prolonged to the outside of the outer skin tube by using electric wires. When current is conducted to the threads, it is possible to check the fracture of the twisted threads, and the fractured threads are not used for thereby preventing safety accidents. Since the core tube and the outer skin tube are made of rubber, cushioning effects occur when unloading heavy things, which lead to preventing the threads from being broken.

It is another object of the present invention to provide a round sling and a method for manufacturing the same in which since a core is formed by twisting a thread with needed strands to meet a preset ratio, when a fracture ratio preset with respect to the working load of the unloading things occurs, it is not used, thus preventing a safety accident in advance.

It is further another object of the present invention to provide a round sling and a method for manufacturing the same in which a plurality of protrusions are protruded from an outer surface of the outer skin tube, a close attachment to the unloading thing is good, and a recovery force is enhanced.

To achieve the above objects, there is provided a round sling which comprises a conductor-coated core in which threads formed of multiple strands are twisted, a core tube made of elastic material and covering an outer side of the core, and an outer skin tube sewed at a sewing line in such a manner that the core tube is wound multiple times along with the core, wherein the threads exposed to both ends of the core tube are positioned in the interior of the outer skin tube.

In the round sling according to the present invention, the threads are twisted with needed strands to meet the set fracture ratio in order to stop the use when the core has a set fracture ratio preset for the working load limit in case of unloading things. The fracture ratio is (pb2/WLL)*100. When the failure force F is WLL*SF, the weight applied to the core tube T as compared to the failure force F is Pb2, it is 3% in minimum, and 10% in maximum.

The round sling according to the present invention is characterized in that the core is formed of the threads twisted with strands to meet the set fracture ratio Fd % set to stop the use when the set fracture Fd % reaches with respect to the working load limit WLL depending on the unloading things.

The round sling according to the present invention is characterized in that a plurality of protrusions are protruded from an outer surface of the outer skin tube.

The round sling according to the present invention is characterized in that a terminal is fixed at a thread protruded from both ends of the core tube.

The method for manufacturing a round sling according to the present invention comprises a step for twisting threads formed of multiple strands, a step for coating the twisted core with a conductor-mixed pigment, a step for drying the conductor coated core, a step for inserting the conductor coated core into a core tube made of an elastic material, a step for preparing a to procedure to wind up the core with the core tube on a winding machine, a step for winding multiple times based on the standard S2-M-2009 stipulated by the Korea occupational safety and health agency based on the weight of use, a step for connecting the contact points at the beginning of the core and the end portion, a step for aligning the core tube in the interior of the outer skin tube, and a step for sewing both ends of the outer skin tube.

The method for manufacturing a round sling according to the present invention is characterized in further comprising a step for rolling on a bobbin after the conductor coated core is dried and for storing the same and then supplying.

The method for manufacturing a round sling according to the present invention is characterized in that the core tube is mixed with rubber after a tube material is imported, and is heated for molding and then is cooled, thus finishing its manufacture.

The method for manufacturing the round sling according to the present invention is characterized in that the outer skin tube is mixed with a tuber after an outer skin tube material is imported, and is heated and molded and cooled, and then is cut, thus finishing its manufacture.

The method for manufacturing the round sling according to the present invention is characterized in that the step for preparing a winding work comprises a step for placing the core with the core tube on a wrinkle member of the winding machine, a step for inserting the outer skin tube into the wrinkle member, and a step for setting the process condition of the winding machine.

The method for manufacturing the round sling according to the present invention is characterized in that the step for preparing a winding work comprises a step for preventing the core from being loosened by performing a connection work after one time winding work.

### ADVANTAGEOUS EFFECTS

The present invention has advantages that a conductor-coated core in which threads formed of multiple strands are twisted is covered by an elastic core tube and is wound on an outer skin tube and is arranged, and the threads protruded from both ends of the core tube are extended into the interior of the outer skin tube and are prolonged to the outside of the outer skin tube by using electric wires. When current is conducted to the threads, it is possible to check the fracture of the twisted threads, and the fractured threads are not used for thereby preventing safety accidents. Since the core tube and the outer skin tube are made of rubber, cushioning effects occur when unloading heavy things, which lead to preventing the threads from being broken.

In the round sling and method for manufacturing the same according to the present invention, since a core is formed by twisting a certain amount of threads in needed strands depending on a preset fracture ratio, when the set fracture ratio occurs with respect to a use weigh of unloading things, it is possible to previously prevent any safety accidents without using the same.

In the round sling and method for manufacturing the same is according to the present invention, a plurality of protrusions are protruded from an outer surface of an outer skin tube, it is likely to attach to the unloading things while enhancing recovery force.

### BRIEF DESCRIPTION OF THE DRAWINGS

The present invention will become better understood with reference to the accompanying drawings which are given only by way of illustration and thus are not limitative of the present invention, wherein;

FIG. 1 is a view of a description of a round sling according to an embodiment of the present invention;

FIG. 2 is a cross sectional view for describing the outer skin tube of FIG. 1;

FIG. 3 is a cross sectional view for describing the core tube and the core of FIG. 2;

FIG. 4 is a view of a description of a winding machine used in the to present invention;

FIG. 5 is a flow chart of a method for manufacturing a round sling according to an embodiment of the present invention; and

FIG. 6 is a view for describing the method for manufacturing a round sling according to an embodiment of the present invention.

< Brief description of reference numerals>

| | |
|---|---|
| 1100: core | 1110: threads |
| 1120: terminal | 1200: core tube |
| 1300: outer skin tube | 1310: sewing line |
| 1320: protrusions | 2000: winding machine |
| 2100: wrinkle member | 3000: measuring units |
| 3100: electric wire | |

### MODES FOR CARRYING OUT THE INVENTION

The round sling and method for manufacturing the same according to a preferred embodiment of the present invention will be described with reference to the accompanying drawings.

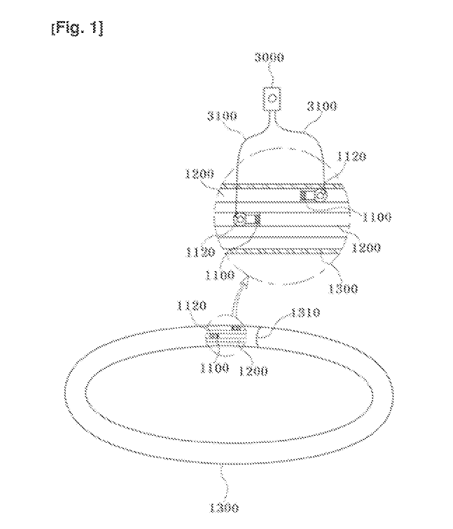

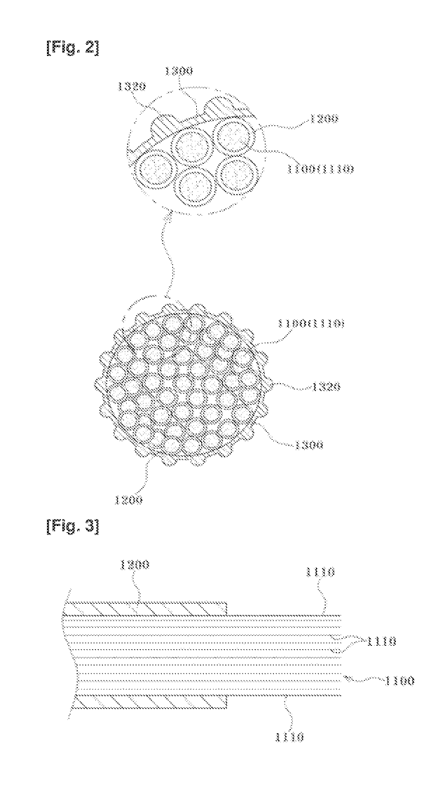

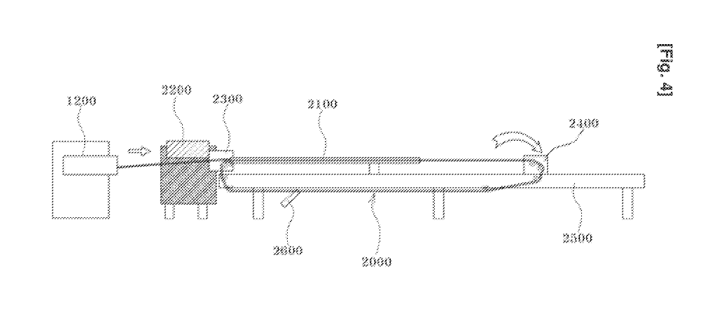

FIG. 1 is a view of a description of a round sling according to an embodiment of the present invention, and FIG. 2 is a cross sectional view for describing the outer skin tube of FIG. 1, and FIG. 3 is a cross sectional view for describing the core tube and the core of FIG. 2.

The round sling comprises a core 1100 which is made by twisting treads 1110 of multiple strands and is coated by dipping in a conductor pigment; a core tube 1200 which is made of an elastic material and is molded to cover on an outer side of the core; and an outer skin tube 1300 which is covered to be aligned in a state that the core tube is wound multiple times along with the core, and is sewed along a sewing line 1310 wherein the thread 1110 protruded from both ends of the core tube 1200 is positioned in the interior of the outer skin tube 1300.

The fracture of the main weight can be easily checked by supplying an electric power to both ends of the core 1100 formed of threads 1110 before use, during use or after use by conductor-coating on the threads 1110 of the core 1100, so the threads are not used in case of fracture, thus preventing safety accidents.

The core can be protected by inserting the core 1100 into each core tube 1200, thus minimizing serial fractures due to the damages of a specific portion when in use, and the contact or pecking of a sharp portion can be prevented, thus protecting the core 1100 which receives main loads.

The core tube 1200 and the outer skin tube 1300 are made of synthetic resin or rubber elastic material, thus having an excellent anti-abrasion performance, friction force, flexibility, recovery force and smoothness.

The terms, symbols and formulas used in the present invention will be described with reference to the following table.

TABLE 1

| No | Names | Symbols | Formulas |
|---|---|---|---|
| 1 | Denior | D | |
| 2 | Working load limit WLL | WLL | |
| 3 | Failure force | F | (F = WLL * SF) |
| 4 | Safety factor (SF should be | SF | |
| | higher than7) | | |
| 5 | Tensional strength of Denior D | Pa | |
| 6 | Number of twisted threads of | Na | |
| | Denior | | |
| 7 | Twisted Denior | Da | (Da = D * Na) |
| 8 | Tensional strength of twisted | Pb | (Pb = Pa * Na) |
| | Denior Da | | |
| 9 | Winding number of Denior Da | Nb | Above |
| | based on safety ratio | | Nb = “{(F/Pb)/2}” |
| 10 | Product design fracture strength | Fa | (Fa = Pb * Nb * 2) |
| 11 | Product design safety factor | SF1 | (SF1 = Fa * Na) |
| 12 | Core tube (1200) | T | |
| 13 | Tensional strength test of | Pb1 | (test result after |
| | twisted threads Da | | manufacture) |
| 14 | Pb1 test design fracture | Fb | (Fb = Pb1 * Nb * 2) |
| | strength | | |
| 15 | Pb1 test design safety factor | SF2 | (SF2 = Fb/WLL) |
| 16 | Safety factor difference between | SF3 | (SF3 = SF2 − SF1) |
| | product design and Pb1 test | | |
| | design | | |
| 17 | Failure force difference between | Fc | (Fc = \|Fb − Fa\|) |
| | product design and Pb1 test | | |
| | design | | |
| 18 | Fb efficiency difference as | F % | (Fc/Fa) * 100 |
| | compared to Fa | | |
| 19 | Average Fa strength | Fa % | |
| | compensation ratio based on | | |
| | winding of core | | |
| 20 | Strength compensation ratio of | Fb % | (\|F %\| ++ Fa % |
| | F % and Fa % as compared | | |
| | to Fa | | |
| 21 | Number of design change | Nc | {Nb + (Nb * Fb %)} |
| | windings of Da based on safety | | |
| | factor | | |
| 22 | Product failure force test for Db | Fd | test result after |
| | design availability test | | manufacture |
| 23 | Weight applied to core tube | Pb2 | Minimum 3% to |
| | (1200) T as compared to F | | maximum 10% |
| 24 | Weight damage ratio as | Fd % | (Pb2/WLL) * 100 |
| | compared to WLL | | |
| 25 | Number of insertions of Nc into | Ta | Nc/n = more than |
| | T core tube 1200 | | 11 times |
| 26 | Failure force applied into T core | Fe | (Ta * Pb1) |
| | tube 1200 | | |

Here, the core 1100 is made of threads twisted with a needed number of strands to meet the set fracture ratio Fd % in order to prevent the use when the set fracture ratio Fd % has reached with respect to the working load limit WLL based on the unloading things.

Fd %=(Pb2/WLL)*100, and when the failure force F=WLL*SF, the weight applied to the core tube (1200; T) as compared to the failure force F is Pb2, and it is 3% in minimum and 10% in maximum.

The design of the fracture strength Fa meeting higher than the safety factor (SF) 7 with respect to the material selection and strength of the core and the working load limit WLL is determined, and the ratio of the fracture weight applied to the core tube based on the minimum fracture weight and the fracture weight depending on the safety factor of the working load limit is set, and the process is performed. When the fracture of the working load limit when in use exceeds a set value, a certain signal is transmitted to stop the use. When the strength is reduced by more than 10%, the damages occur by more than 70% of the working load limit based on the safety ratio 7. For example, when the working load limit is 10 tons, and the safety factor is 7, and the fracture weight is 70 tons, the strength decrease of 10% of 7 tons is 7 tons, which corresponds to 70% of the working load limit. The fracture ratio Fd % based on the safety factor in the core tube causes to send a signal for stopping the use in case of the fracture by applying 3˜10% of the fracture weight into the core tube. For example, when the working load limit is 10 tons, and the safety factor is 7, and the fracture weight is 70 tons, and the ratio of the strength applied to the core tube is 5%, 5% of 70 tons is 3.5 tons, which corresponds to 35% of the working load limit.

When the Denior is D, and the number of the twisted Denior is Na, and the twisted Denior is Da, Da=D*Na, and when the core tube 1200 is T, and the number of winding design changes of Da based on the safety ratio is Nc, and the number of the insertions of Nc in the core tube 1200 is Ta, and Ta=Nc/n=11 times, the portions for determining the fracture ratio Fd % at the time of design is performed at the steps of Da and Ta, which are finally determined based on the material, strength and work efficiency of the industrial threads.

The S-Mark set by the Korea occupational safety and health agency contains the safety authorization technology standard on the artificial fiber round sling as the standard number S2-M-2009 of which item 3 of the technology standard stipulates that the manufacture method of the core is based on each sub-item in it's the item B as a safety condition, and in item 2, it is stipulated that the core is made by winding skein at least 11 times in its technology standard.

When the number of winding of the core based on the working load of the round sling is determined, for example, even the working load of 1 ton or 100 tons should be wound at least 11 times. In case that the round sling is 100 tons, when it is wound 12 times, one core corresponds to the core (threads) having a larger strength.

In the conventional art, it is impossible to determine whether or not the round sling is discharged because the degree of the damage of the core cannot be recognized. In the present invention, the round sling is characterized in that the core 1100 is formed by twisting the threads with an appropriate number of strands to meet the set fracture ratio. When the fracture ratio Fd % determined with respect to the working load limit WLL of the unloading things detects the conduction of the current, the use is stopped, thus preventing safety accident in advance. Since the core 1100 formed of the threads 1110 is inserted into the core tube 1200, the damage of the core does not influence another core.

A plurality of protrusions 1320 are protruded from the outer surface of the outer skin tube 1300.

The protrusions 1320 formed on the outer surface of the outer skin tube 1300 are closely attached to the products when unloading things, and the shapes of the round sling are maintained, thus enhancing recovery force.

As shown in FIG. 1, the terminal 1120 is fixed at the threads 1110 protruded from both ends of the core tube 1200, and an electric wire 3100 is connected with the terminal 1120, thus measuring the conduction of the current by using the current measuring unit 3000.

When the electric wire 3100 connected with the terminal 1200 is extended to the outside of the outer skin tube 1300, the electric wire 3100 is connected with the current measuring unit 3000, thus judging whether the core 1100 of the core tube 1200 is short circuit or not.

The core 1100 twisted with multiple threads 1110 is coated with conductor-mixed pigment and is dried, so the conductor pigment penetrates into each thread 1110 which forms the core 1100.

The conductor coated core is inserted into the core tube 1200 made of elastic material, thus preventing the core 1100 from being damaged, and the core formed with the core tube is wound using the winding machine 2000 and is accommodated in the outer skin tube 1300 and is sewed, thus preventing the distortion of the core 1100 while preventing abrasion, pecking and outer skin damages.

When the power is supplied by connecting the terminal 1120 to the front and end portions of the core 1100, the damages of the core 1100, if any, can be checked. When damaged, the use is stopped, thus preventing safety accidents.

Since both ends of the outer skin tube 1300 are sewed, it is possible to prevent any damages of the core 1100 which might occur like in the is conventional art.

The method for manufacturing the round sling according to the present invention will be described.

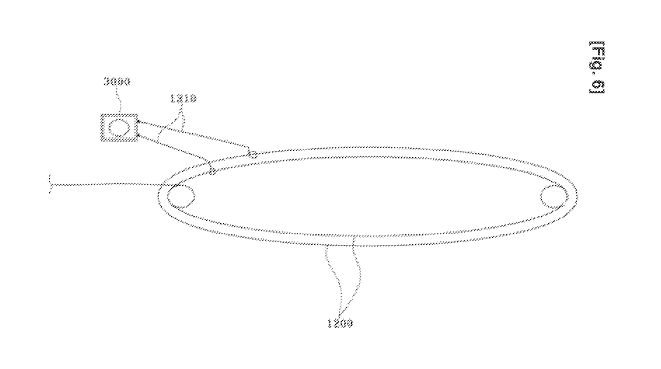

As shown in FIG. 5, the method for manufacturing a round sling comprises a step S11 for twisting threads 1110 of multiple strands; a step S12 for coating the twisted core 1100 with a conductor pigment; a step S13 for drying the conductor coated core; a step S14 for inserting the conductor coated core into a core tube 1200 made of an electric material; a step S15 for preparing a process condition for winding the core tube-molded core by using a winding machine; a step S16 for winding multiple times the core tube-molded core depending on the working load; a step S17 for connecting the terminal 1120 to the front and end portions of the core 1100; a step S18 for aligning the core tube 1200 in the interior of the outer skin tube 1300; and a step S19 for sewing both ends of the outer skin tube 1300.

The core 1100 made by twisting multiple threads 1110 is coated with the conductor pigment and is dried, so the conductor pigment penetrates into each thread 1110.

When the conductor coated core is inserted into the core tube 1200 made of elastic material, the core 1100 can be easily prevented from being damaged. The core with the core tube is wound using the winding machine 2000 and is accommodated in the outer skin tube 1300 and is sewed, thus preventing any distortion of the core 1100 and abrasion and pecking and outer skin damage.

The terminal 1120 is connected with the front and end portions of the core 1100. When electric power is supplied, it is possible to check whether or not the core is damaged. In case that the core is damaged, the use is stopped, thus preventing safety accident.

Since both ends of the outer skin tube 1300 are sewed, it is possible to prevent the damages of the core which occurs due to sewing like in the conventional art.

There is further provided a step S21 in which the conductor coated core 1100 is dried and rolled on the bobbin and is stored.

Therefore, when the conductor coated core 1100 is dried and rolled on the prepared bobbin and is stored, and then is inserted into the core tube 1200 made of an elastic material, the core 1100 can be supplied under diverse conditions.

The core tube 1200 is mixed in a step S32 with the rubber after tube materials are imported in a step S31, and is heated in a step S33, and then is cooled in a step S34 via a step S30.

In other words, the core tube 1200 is manufactured via steps in is which a tube material is imported and mixed with rubber and is heated and molded and then is cooled. At this time, the core 1100 is insert-supplied during the extrusion molding, so the rubber core tube 1200 is integrally molded in the conductor coated core 1100.

The outer skin tube 1300 is manufactured via a step S40 in such a manner that it is mixed in a step S42 with rubber after an outer skin tube material is imported in a step S41, and is heated in a step S43, and then is cooled in a step S44, thus being cut in a step S45 depending on the length of the round sling.

In other words, the outer skin tube 1300 is mixed with rubber after an outer skin tube material is imported, and is heated and molded, and then cooled, thus being cut depending on the length of the round sling.

The mixing, heating and cooling procedures of the tube materials in order to manufacture the core tube 1200 and the outer skin tube 1300 are performed under the known work conditions of the tube materials, but might change depending on situations.

The step S15 for preparing rounding comprises a step S151 for placing the core tube-molded core on the wrinkle member 2100 of the winding machine 2000, a step S152 for inserting the outer skin tube 1300 into the wrinkle member 2100, and a step S153 for setting the process conditions of the winding machine 2000.

The work for inserting the outer skin tube 1300 into the wrinkle member 2100 is performed by inserting the outer skin tube into the wrinkle member while forming wrinkles at the wrinkle member. The process conditions of the winding machine 2000 serves to set the number of windings.

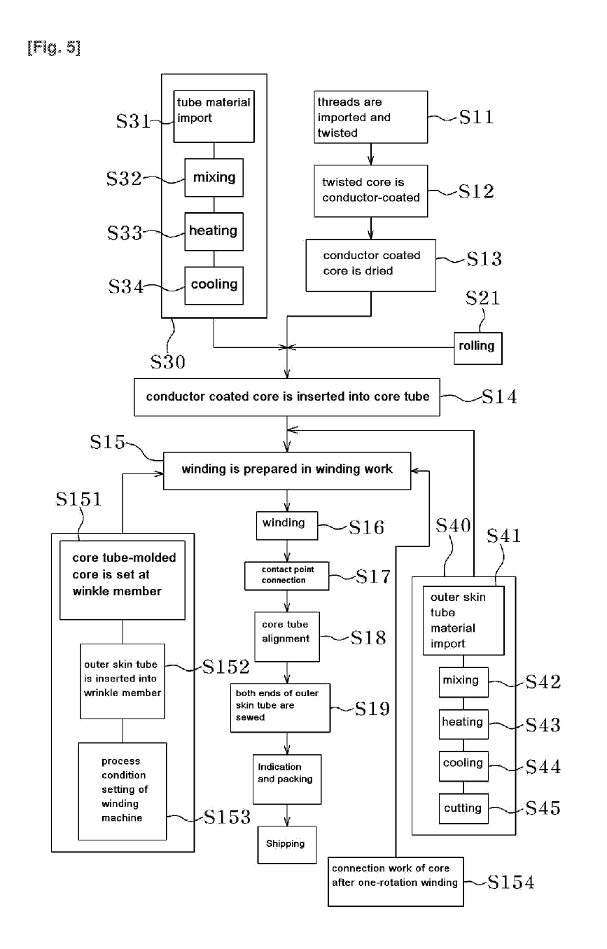

As shown in FIG. 4, when the twisted core tube 1200 is supplied to the body roller 2300 rotating by means of Slidacs 2200, it is wound on a frame roller 2400 via the wrinkle member 2100 installed at the top of the frame 2500. At this time, the tension degree is adjusted by means of a tension support member 2600 installed at a lower side of the frame 2500.

The step S15 for preparing winding, as shown in FIG. 6, comprises a step S154 for preening the core 1100 from being loosened with the aid of the connection work after one-rotation winding is performed.

The core 1100 is reliably fixed during the winding work with the aid of the connection work after one-rotation winding work is performed. A certain step for forming a knot might be added for preventing the core 1100 from being loosened after winding work is finished.

In more details, the twisted core tube 1200 is rotated one time and wound and tied, and is wound as many as a desired revolution. The terminal 1120 is connected with the tied portion, and the electric wire 3100 is connected with the terminal 1120, and the short circuit is checked by using the current measuring unit 3000.

During the manufacture of the round sling, when the step S19 for sewing both ends of the outer skin tube 1300 is finished, the purposes of use or markings are indicated at a certain portion of the outer skin tube 1300, and then the products are packed and shipped.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A round sling, comprising:
a core which is made by twisting treads of multiple strands and is coated by dipping in a conductor pigment;
a core tube which is made of an elastic material and is molded to cover on an outer side of the core; and
an outer skin tube which is covered to be aligned in a state that the core tube is wound multiple times along with the core and is sewed along a sewing line, wherein the thread protruded from both ends of the core tube is positioned in the interior of the outer skin tube.

2. A round sling according to claim 1, wherein said core is wound with an appropriate number of threads depending on the fracture ratio Fd % set in order to prevent the use when the set fracture ratio Fd % reaches with respect to a working load limit WLL based on a unloading thing, and the fracture ratio Fd %=(Pb2/WLL)*100, and the failure force F=WLL*SF, and the weight applied to the core tube (T) as compared to the failure force F is Pb2, and it is 3% in minimum, and 10% in maximum.

3. A round sling according to claim 1, wherein a terminal is fixed at a thread protruded from both ends of the core tube, and an electric wire is connected to each terminal and is protruded from an outer surface of the outer skin tube.

4. A round sling according to claim 1, wherein a protrusion is protruded from an outer surface of the outer skin tube.

5. A method for manufacturing a round sling, comprising:
a step for twisting threads of multiple strands;
a step for coating the twisted core with a conductor pigment;
a step for drying the conductor coated core;
a step for inserting the conductor coated core into a core tube made of an electric material;
a step for preparing a process condition for winding the core tube-molded core by using a winding machine;
a step for winding multiple times the core tube-molded core depending on the working load;
a step for connecting the terminal to the front and end portions of the core;
a step for aligning the core tube in the interior of the outer skin tube; and
a step for sewing both ends of the outer skin tube.

6. A method for manufacturing a round sling according to claim 5, further comprising a step for drying the conductor coated core, rolling the same on a bobbin and storing and then supplying the same.

7. A method for manufacturing a round sling according to claim 5, wherein said core tube is made via a step in such a manner that a tube material is imported in a step, and is mixed with rubber in a step, and is heated in a step and is cooled in a step.

8. A method for manufacturing a round sling according to claim 5, wherein said outer skin tube is made via a step in such a manner that an outer tube material is imported in a step, and is mixed with rubber in a step, and is heated in a step and is molded, and is cooled in a step and then is cut off in a step.

9. A method for manufacturing a round sling according to claim 5, wherein said step for preparing the winding comprises:
a step for placing the core tube molded core on a winkle member of the winding machine;
a step for inserting the outer sin tube into the wrinkle member; and
a step for setting a process condition of the winding machine.

10. A method for manufacturing a round sling according to claim 1, wherein said step for preparing the winding includes a step for performing a connection work after one-rotation winding for thereby preventing the core from being loosened.

11. A round sling according to claim 2, wherein a terminal is fixed at a thread protruded from both ends of the core tube, and an electric wire is connected to each terminal and is protruded from an outer surface of the outer skin tube.

12. A round sling according to claim 2, wherein a protrusion is protruded from an outer surface of the outer skin tube.
